(19) United States
(12) Patent Application Publication
(10) Pub. No.: US 2010/0202099 A1
(43) Pub. Date: Aug. 12, 2010

(54) THIN FILM CAPACITOR

(75) Inventor: CHIA-FU YEH, TAIPEI (TW)

Correspondence Address: ROSENBERG, KLEIN & LEE, 3458 ELLICOTT CENTER DRIVE-SUITE 101, ELLICOTT CITY, MD, 21043, US

(73) Assignee: LITE-ON CAPITAL INC., TAIPEI (TW)

(21) Appl. No.: 12/704,044

(22) Filed: Feb. 11, 2010

Related U.S. Application Data
(60) Provisional application No. 61/202,265, filed on Feb. 12, 2009.

(30) Foreign Application Priority Data
Jan. 11, 2010 (TW) 099100554

(51) Int. Cl. H01G 4/008; H01G 4/08

(52) U.S. Cl. 361/305; 361/313

(57) ABSTRACT

A thin film capacitor includes a first electrode, second electrode opposite to the first electrode, and a dielectric layered structure disposed between the first and second electrodes and having a doped dielectric layer. The doped dielectric layer contains a dopant therein and has a doping concentration greater than 0 atoms/cm³ and not greater than 10¹⁰ atoms/cm³.

### CROSS-REFERENCE TO RELATED APPLICATION

This application claims priority of U.S. provisional patent application No. 61/202,265, filed on Feb. 12, 2009.

### BACKGROUND OF THE INVENTION

1. Field of the Invention

This invention relates to a thin film capacitor, more particularly to a thin film capacitor with a doped dielectric layer having a doping concentration not greater than 10¹⁰ atoms/cm³.

2. Description of the Related Art

Referring to FIG. 1, a conventional capacitor 1 having a tri-layered structure includes a first electrode 11, a second electrode 12 opposite to the first electrode 11, and a dielectric layer 13 made from an insulator. As shown in the following formula (I),

$$C = ɛ \frac{A}{d} \qquad ( I )$$

the capacitance (C) of the tri-layered structure of the conventional capacitor 1 is proportional to the area (A) of either one of the first electrode 11 and the second electrode 12 and the permittivity (ε) of the dielectric layer 13, and is inversely proportional to the layer thickness (d) of the dielectric layer 13. The capacitance (C) can be increased by increasing the area (A) of either one or both of the first and second electrodes 11, 12, and the permittivity (ε) of the dielectric layer 13, and by reducing the layer thickness (d) of the dielectric layer 13.

The permittivity (ε) of the dielectric layer 13 is an intrinsic property related to the insulating property of the dielectric material; the ability to generate induced dipole moments under an electric field, and the magnitude of the self-excited dipole moments. The higher the permittivity of a dielectric layer, the greater the ability will be to prevent the occurrence of current leakage and breakdown of a capacitor under an applied voltage, and the higher will be the charge storing capacity, i.e., the higher the capacitance (C) of the capacitor. It has been known in the art to develop a giant dielectric material, such as CaCu₃Ti₄O₁₂, which has a high permittivity, for increasing the capacitance (C) of the capacitor.

The dielectric layer 13 used in the conventional capacitor 1 is generally formed by a sintering process under a sintering temperature higher than 800° C. for increasing the crystal property thereof and for decreasing the porosity thereof so as to resist the electric field generated in the conventional capacitor 1 and to increase the breakdown voltage. However, the layer thickness (d) of the dielectric layer 13 thus formed is greater than several micrometers and cannot be decreased. Hence, the capacitance (C) of the conventional capacitor 1 cannot be further increased, and the size of the conventional capacitor 1 cannot be miniaturized.

The layer thickness (d) of the dielectric layer 13 can be decreased by using chemical vapor deposition (CVD) techniques. However, the dielectric layer 13 thus formed has a poor crystal property and a high porosity. As a consequence, the conventional capacitor 1 with the dielectric layer 13 formed by CVD techniques is likely to have a lower breakdown voltage and a higher current leakage.

As dimensions of integrated circuit (IC) devices continue to be scaled down, miniaturization of capacitors that are indispensable in the IC devices is also becoming significant. Thin film capacitors are typically used in IC devices, such as dynamic random access memory (DRAM), and normally include a layer of a dielectric material sandwiched between two electrode plates. Conventionally, the dielectric materials used in the thin film capacitors include silicon dioxide, silicon nitride, and the like. However, when the layer thickness is reduced to a certain extent, these dielectric materials exhibit a relatively high current leakage and a low breakdown voltage.

Therefore, there is a need in the art to provide a thin film capacitor that has a high breakdown voltage and a low current leakage so as to be suitable for integration into IC devices.

### SUMMARY OF THE INVENTION

Therefore, the object of the present invention is to provide a thin film capacitor that can overcome the aforesaid drawbacks of the prior art.

According to this invention, there is provided a thin film capacitor that comprises a first electrode, a second electrode opposite to the first electrode, and a dielectric layered structure disposed between the first and second electrodes and having a doped dielectric layer. The doped dielectric layer contains a dopant therein and has a doping concentration greater than 0 atoms/cm³ and not greater than 10¹⁰ atoms/cm³.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a cross-sectional view of a conventional capacitor;

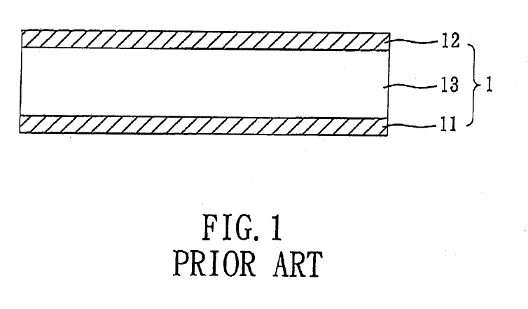

FIG. 2 is a cross-sectional view of the first preferred embodiment of a thin film capacitor according to this invention;

FIG. 3 is a cross-sectional view of the second preferred embodiment of the thin film capacitor according to this invention;

FIG. 4 is a cross-sectional view of the third preferred embodiment of the thin film capacitor according to this invention; and

FIG. 5 is a plot of current (I) vs. applied voltage (V) for the thin film capacitor of Example 1 (E1) and Comparative Example (CE).

### DETAILED DESCRIPTION OF TEE PREFERRED EMBODIMENTS

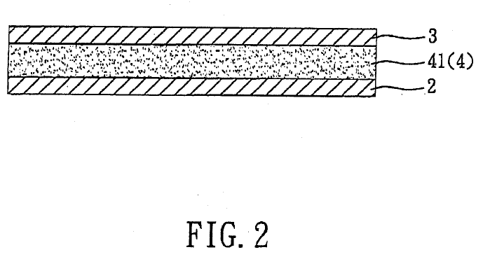

Referring to FIG. 2, the first preferred embodiment of a thin film capacitor according to the present invention is shown to include a first electrode 2, a second electrode 3 opposite to the first electrode 2, and a dielectric layered structure 4 disposed between the first and second electrodes 2, 3 and having a doped dielectric layer 41. The doped dielectric layer 41 contains a dopant therein and has a doping concentration greater than 0 atoms/cm³ and not greater than 10¹⁰ atoms/cm³. The dopant is selected from the group consisting of transition elements, Group IIIA elements, Group VA elements, and combinations thereof.

Preferably, the doping concentration of the doped dielectric layer 41 ranges from 10⁶ atoms/cm³ to 10¹⁰ atoms/cm³.

The transition elements include Group IB, Group IIB, Group IIIB, Group IVB, Group VB, Group VIB, Group VIIB, and Group VIIIB.

Preferably, the doped dielectric layer 41 is made from an oxide, and the dopant is selected from the group consisting of Ti, Mn, Fe, Co, Ni, Zn, Ga, Al, P, As, and combinations thereof. In an example, the oxide is SiO₂.

Preferably, the doped dielectric layer 41 has a layer thickness ranging from 50 nm to 3000 nm. More preferably, the layer thickness of the doped dielectric layer 41 ranges from 50 nm to 500 nm.

Preferably, at least one of the first and second electrodes 2, 3 is made from a metallic conductive material.

Preferably, at least one of the first and second electrodes 2, 3 is made from a magnetic material.

Preferably, the magnetic material is a ferromagnetic material or an antiferromagnetic material. More preferably, the ferromagnetic material is a Fe-based alloy, a Co-based alloy, a Ni-based alloy, or combinations thereof, and the antiferromagnetic material is a Mn-based alloy. When the first and second electrodes 2, 3 made from the magnetic material are formed by sputtering techniques, a magnetic field with a predetermined direction can be applied to a reactive chamber (not shown) in which the magnetic material is formed so as to fix the magnetic moment of the magnetic material and to increase the net magnetization of the magnetic material.

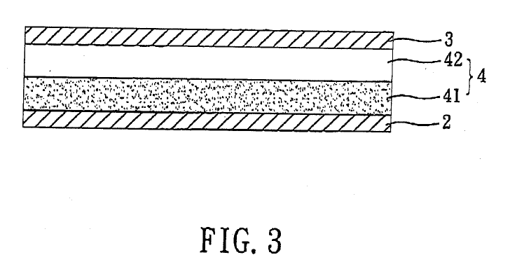

Referring to FIG. 3, the second preferred embodiment of the thin film capacitor according to this invention is similar to the first preferred embodiment, except that the dielectric layered structure 4 further has an undoped dielectric layer 42.

Preferably, the undoped dielectric layer 42 is made from an oxide, such as SiO₂.

Preferably, the undoped dielectric layer 42 has a layer thickness ranging from 50 nm to 3000 nm. More preferably, the layer thickness of the undoped dielectric layer 42 ranges from 50 nm to 500 nm.

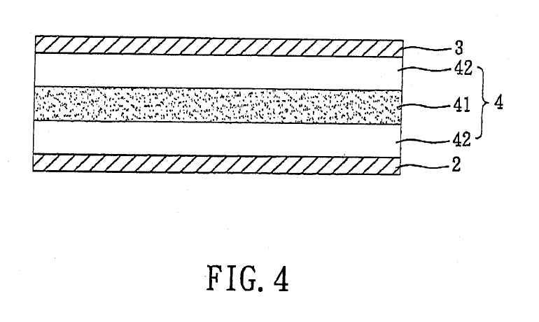

Referring to FIG. 4, the third preferred embodiment of the thin film capacitor according to this invention is similar to the second preferred embodiment, except that the dielectric layered structure 4 has two undoped dielectric layers 42 sandwiching the doped dielectric layer 41 therebetween.

The following Example and Comparative Example are provided to illustrate the merits of the preferred embodiment of the invention, and should not be construed as limiting the scope of the invention.

### Example 1 (E1)

The thin film capacitor of Example 1 (E1) formed by sputtering techniques includes a doped SiO₂ layer doped with Al atoms and Co atoms therein. The doped SiO₂ layer has a layer thickness of 50 nm and a doping concentration of about 10⁷ atoms/cm³. Two electrodes sandwich the doped SiO₂ layer therebetween. Each of the electrodes has a size of 200 μm×600 μm×30 nm, and is made from a magnetic material of FeCoNi alloy, so as to generate a built-in magnetic field of about 680 Oe to 1500 Oe in the thin film capacitor of Example 1 (E1). The layer structure of the thin film capacitor of Example 1 (E1) is FeCoNi Alloy/Al, Co-doped SiO₂/FeCoNi Alloy.

### Comparative Example (CE)

The thin film capacitor of Comparative Example (CE) has a layer structure similar to that of Example 1 (E1), except that the doped SiO₂ layer is replaced with an undoped SiO₂ layer having a layer thickness of 50 nm, and that the electrodes are made from Pt. The layer structure of the film capacitor of Comparative Example (CE) is Pt/undoped-SiO₂/Pt.

### <Electric Analysis>

Voltage endurance test was conducted for Example (E1) and Comparative Example (CE). The results show that the thin film capacitor of Example 1 (E1) can endure an applied voltage of 275 V applied thereto without breakdown, while the thin film capacitor of Comparative Example (CE) only has a breakdown voltage of about 7 v to 8 V.

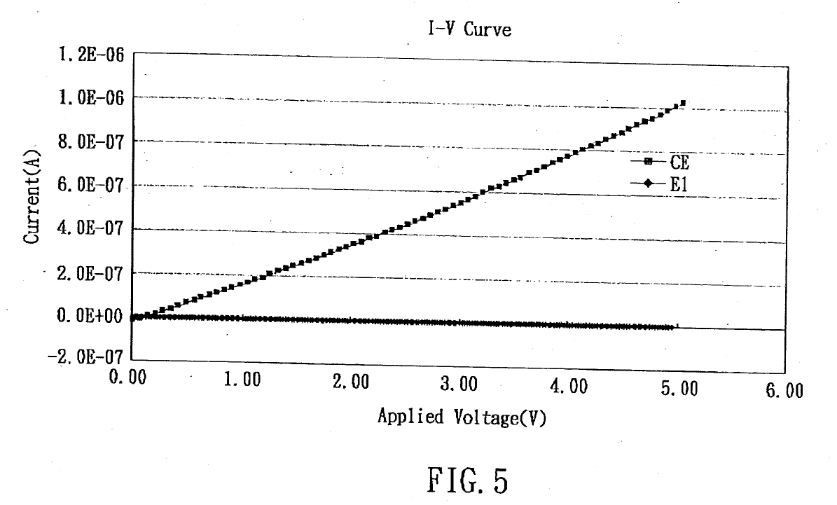

FIG. 5 is a plot of measured current (I) vs. applied voltage (V) to compare the electrical properties of Example 1 (E1) and Comparative Example (CE). The results show that the thin film capacitor of Example 1 (E1) maintains a current leakage approximate to zero (less than 10⁻⁸ A, measured by KEITHLEY 2400) when the applied voltage is increased from 0 V to 5 v, while the Comparative Example (CE) has a current leakage increasing from 0 A to 10⁻⁶ A when the applied voltage is increased from 0 V to 5 V.

In conclusion, by using the doped dielectric layer 41, which has the doping concentration not greater than 10¹⁰ atoms/cm³, in the thin film capacitor according to the present invention, the breakdown voltage can be increased and the current leakage can be considerably reduced.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A thin film capacitor comprising:
a first electrode;
a second electrode opposite to said first electrode; and
a dielectric layered structure disposed between said first and second electrodes and having a doped dielectric layer, said doped dielectric layer containing a dopant therein and having a doping concentration greater than 0 atoms/cm³ and not greater than 10¹⁰ atoms/cm³.

2. The thin film capacitor of claim 1, wherein said doping concentration ranges from 10⁶ atoms/cm³ to 10¹⁰ atoms/cm³.

3. The thin film capacitor of claim 1, wherein said IS dopant is selected from the group consisting of transition elements, Group IIIA elements, Group VA elements, and combinations thereof.

4. The thin film capacitor of claim 3, wherein said doped dielectric layer is made from an oxide, said dopant being selected from the group consisting of Ti, Mn, Fe, Co, Ni, Zn, Ga, Al, P, As, and combinations thereof.

5. The thin film capacitor of claim 1, wherein said doped dielectric layer has a layer thickness ranging from 50 nm to 3000 nm.

6. The thin film capacitor of claim 5, wherein said layer thickness of said doped dielectric layer ranges from 50 nm to 500 nm.

7. The thin film capacitor of claim 1, wherein said dielectric layered structure further has at least one undoped dielectric layer.

8. The thin film capacitor of claim 7, wherein said dielectric layered structure has two undoped dielectric layers sandwiching said doped dielectric layer therebetween.

9. The thin film capacitor of claim 7, wherein said undoped dielectric layer is made from an oxide.

10. The thin film capacitor of claim 7, wherein said undoped dielectric layer has a layer thickness ranging from 50 nm to 3000 nm.

11. The thin film capacitor of claim 10, wherein said layer thickness of said undoped dielectric layer ranges from 50 nm to 500 nm.

12. The thin film capacitor of claim 1, wherein at least one of said first and second electrodes is made from a metallic conductive material.

13. The thin film capacitor of claim 1, wherein at least one of said first and second electrodes is made from a magnetic material.

14. The thin film capacitor of claim 13, wherein said magnetic material is a ferromagnetic material or an antiferromagnetic material.

15. The thin film capacitor of claim 14, wherein said ferromagnetic material is a Fe-based alloy, a Co-based alloy, a Ni-based alloy, or combinations thereof, said antiferromagnetic material being a Mn-based alloy.
